(19) United States
(12) Patent Application Publication
(10) Pub. No.: US 2005/0226126 A1
(43) Pub. Date: Oct. 13, 2005

(54) Optical pick-up and optical recording medium recording/reproduction apparatus

(75) Inventors: Tsuguhiro Abe, Chiba (JP); Masato Tsujinaka, Kanagawa (JP); Norimasa Matsuo, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/070,206

(22) Filed: Mar. 3, 2005

(30) Foreign Application Priority Data
Mar. 19, 2004 (JP) P2004-081029

(51) Int. Cl. G11B 7/00

(52) U.S. Cl. 369/121; 369/112.01

(57) ABSTRACT

The range of air conversion optical path length L of all optical components in the forward passage of an optical system between a laser emission point and the surface of a disc-shaped recording medium is determined by:
i(n₀×d)+ΔL/2<L<(i+1)(n₀×d)−ΔL/2 (i is an arbitrary integer)
where d is resonator length of a laser diode, n₀ is active layer refractive index of the laser diode, and ΔL is acceptable surface blurring in the specification of the disc-shaped recording medium, thereby reducing laser noise (optical feedback noise) that is generated when emitted laser beam from a laser diode is interfered with the optical feedback, which is a part of laser beam that has been focused on the recording surface of the disc and has moved back through the forward passage of the optical system to return to the laser diode.

### BACKGROUND OF THE INVENTION

1. Field of the Invention

The present invention relates to an optical pick-up and an optical recording medium recording/reproduction apparatus capable of reducing optical feedback noise in an optical system of an optical recording medium.

This application claims priority of Japanese Patent Application No. 2004-081029, filed on Mar. 19, 2004, the entirety of which is incorporated by reference herein.

2. Description of the Related Art

In an optical pick-up using a laser diode, laser beam that has been emitted from the laser diode and focused onto the recording surface of a disc partly moves back through the forward passage of an optical system and returns to the laser diode. This returning laser beam is referred to as “optical feedback” and interferes with the emitted laser beam, causing laser noise (optical feedback noise). The optical feedback noise is a longstanding problem since the optical pick-up using the laser diode has been developed. Various countermeasures have been taken to cope with this problem. For example, the following methods are known: a method of superposing a high frequency wave of about several hundreds of MHz to several GHz on laser current to make a light emitting pattern that repeats ON/OFF operation quickly; a method using so-called a self-excited oscillation laser that spontaneously and quickly repeats ON/OFF operation, which is obtained by devising the structure of a laser emission system; and a method of disposing a λ/4 wavelength plate in an optical path to allow beam polarization direction to rotate by 90°, thereby reducing influence on the forward passage of the optical system. Further, Jpn. Pat. Appln. Laid-Open Publication No. 5-275785 discloses a technique of setting the effective distance between a resonator and conjugate point to (m+½) times (m is an integer) the resonator length of the laser diode, thereby reducing the optical feedback noise.

In recent years, a reduction in the size or thickness of a reproduction apparatus for recording media such as a CD (Compact Disc), an MD (Mini Disc), or a DVD (Digital Versatile Disc) and a portable device such as a thin-type note PC has been increasingly demanded. Accordingly, further miniaturization of a drive to be used and entire optical pick-up system has been demanded. This accelerates a reduction in the optical path length. Under the above circumstance, the methods cited above are no longer effective countermeasures for reducing the optical feedback noise.

FIG. 1 shows a relationship between laser coherence and an optical path length, which is a chief cause of the optical feedback noise. FIG. 2 shows a result obtained by detecting the laser coherence as jitter in an actual optical pick-up system. In general, the amount of noise caused by interference between emitted laser beam and the optical feedback depends on the optical path length. Assuming that d is the resonator length of a laser diode and n is the refractive index of an active layer, air conversion optical path length L of all optical components in the forward passage of an optical system between a laser emission point and the surface of a disc-shaped recording medium has a plurality of peaks at some intervals, which meets the following equation. The air conversion optical path length is represented by: (refractive index of a medium, such as lens, capable of transmitting laser beam)×(optical path length of laser beam passing the medium). The air conversion optical path length L of all optical components in the forward passage of an optical system is the total sum of the air conversion optical path lengths of all media including even the air interval between a laser emission point and the surface of a disc-shaped recording medium.
L=i×(n×d)

(i is an arbitrary integer)

As can be seen from the graph shown in FIG. 1, the shorter the optical path length through which the emitted laser beam returns to the laser emitting device is, the higher the degree of interference between the optical feedback and emitted laser beam is, or the higher the probability of occurrence of the interference. Accordingly, when the optical path length is reduced, optical feedback noise occurs with high probability.

### SUMMARY OF THE INVENTION

The present invention has been made in view of the above situation, and an object thereof is to provide an optical pick-up and an optical recording medium recording/reproduction apparatus capable of reducing both the optical path length and optical feedback noise caused by interference of the optical feedback and capable of realizing a reduction in the size, thickness, and weight.

According to an aspect of the present invention, there is provided an optical pick-up comprising a laser diode, wherein air conversion optical path length L of all optical components in the forward passage of an optical system between a laser emission point and the surface of a disc-shaped recording medium is represented by the following inequality:
i(n₀×d)+ΔL/2<L<(i+1)(n₀×d)−ΔL/2

(i is an arbitrary integer)

where d is resonator length of a laser diode, n₀ is active layer refractive index of the laser diode, and ΔL is acceptable surface blurring in the specification of the disc-shaped recording medium.

The air conversion optical path length L is represented by the following equation:
L=n₁l₁+n₂l₂+ . . . +nₘlₘ+ . . .
where nₘ is refractive index of each medium in the optical path, and lₘ is length of the medium, and satisfies the above inequality. In particular, a parallel plate having the medium refractive index and length that satisfy the air conversion optical path length L is provided in the optical path to optimize the air conversion optical path length L based on the refractive index and length of the parallel plate. Further, the air conversion optical path length L can also be optimized by the thickness or refractive index of at least one lens of the lenses disposed in the optical system.

It is preferable that the lens thickness be optimized based on the length in the radial direction of the disc-shaped recording medium that faces the optical pick-up in order to reduce the thickness of the optical pick-up.

The optical pick-up may include a laser coupler constituted by a light emitting device and a light detection means that receives the laser beam that has been modulated by the surface of the disc-shaped recording medium, the laser coupler having a flat glass capable of transmitting the laser light that protects the inside of the coupler. The air conversion optical path length L can be optimized based on the thickness of the flat glass.

The optical pick-up may include a laser coupler constituted by a light emitting device and a light detection means that receives the laser beam that has been modulated by the surface of the disc-shaped recording medium, and a coupling lens is disposed near the laser coupler and changes the light flux into substantially parallel light flux. The air conversion optical path length L can be optimized based on the thickness of the coupling lens.

The optical pick-up may include a laser coupler constituted by a light emitting device and a light detection means that receives the laser beam that has been modulated by the surface of the disc-shaped recording medium, and a coupling lens is disposed near the laser coupler and changes the light flux into substantially parallel light flux, and a liquid crystal optical device that compensates phase difference of the light flux. The air conversion optical path length L can be optimized based on the thickness of the liquid crystal optical device.

The parallel plate may serve as an optical device having functions corresponding to those of the flat glass, coupling lens, and liquid crystal device.

According to an another aspect of the present invention, there is provided an optical recording medium recording/reproducing apparatus rotatably driving an optical recording medium, having an optical pick-up for recoding/reproduction that is moved in the radial direction of the optical recording medium by a feed means, the optical pick-up having a laser diode, wherein air conversion optical path length L of all optical components in the forward passage of an optical system between a laser emission point and the surface of a disc-shaped recording medium is represented by the following inequality:
i(n₀×d)+ΔL/2<L<(i+1)(n₀×d)−ΔL/2

(i is an arbitrary integer)

where d is resonator length of a laser diode, n₀ is active layer refractive index of the laser diode, and ΔL is acceptable surface blurring in the specification of the disc-shaped recording medium.

According to the optical pick-up and optical recording medium recording/reproduction apparatus of the present invention, laser characteristics can be assured in the range of the optical path length including the surface blurring of the disc-shaped recording medium. Further, the optical feedback noise can be reduced without the need of using a conventional high-frequency superposed and self-excited laser diode. Therefore, a reduction in the size, thickness, weight, and power consumption can be achieved.

If the optical feedback noise can be reduced by optimizing the air conversion optical path length without using a conventional high-frequency superposed and self-excited laser diode, the tolerance of the laser element itself can be relaxed, contributing to cost reduction and improvement in yield.

### BRIEF DESCRIPTION OF THE DRAWINGS

FIG. 1 is a graph for explaining a relationship between laser coherence and an optical path length, which is a chief cause of the optical feedback noise;

FIG. 2 is a graph for explaining the laser coherence to be detected as jitter in an actual optical pick-up system;

FIG. 3 is a block diagram showing the configuration of an optical disc recording/reproduction apparatus taken as an embodiment of the present invention;

FIG. 4 is a view for explaining an optical pick-up taken as an embodiment of the present invention;

FIG. 5 is a view showing the configuration of a first optical system of the optical pick-up;

FIG. 6 is a view showing the configuration of a second optical system of the optical pick-up; and

FIG. 7 is a view showing the configuration of a third optical system of the optical pick-up.

### DETAILED DESCRIPTION OF THE PREFERRED EMBODIMENTS

An optical disc recording/reproduction apparatus taken as an embodiment of the present invention can be applied to various systems of disc-shaped recording media using light modulation recording or pit recording. More specifically, the optical disc recording/reproduction apparatus according to the embodiment can be configured as a data reproduction apparatus that uses, as a recording medium, pitted discs such as a CD (Compact Disc), a DVD (Digital Versatile Disc), and a UMD (Ultra Mini Disc), or can be configured as a data recording/reproducing apparatus that uses, as a recoding medium, disc-shaped recording media such as an MD (Mini Disc™), a DVD-R/RW, and a CD-R/RW.

An optical pick-up used in the optical recording/reproduction apparatus is one that has a laser diode. In this optical disc recording/reproduction apparatus, the range of the air conversion optical path length L of all optical components in the forward passage of an optical system between a laser emission point and the surface of a disc-shaped recording medium is determined by the resonator length of the laser diode, active layer refractive index of the laser diode, and acceptable surface blurring in the specification of the disc-shaped recording medium, thereby reducing laser noise (optical feedback noise) caused by interference between the optical feedback, which is a part of the laser beam that has been focused on the recording surface of the disc and has moved back through the forward passage of the optical system to return to the laser diode, and laser beam emitted from the laser diode.

An embodiment of the optical disc recording/reproduction apparatus having an optical pick-up according to the present invention will be described below in detail with reference to the accompanying drawings.

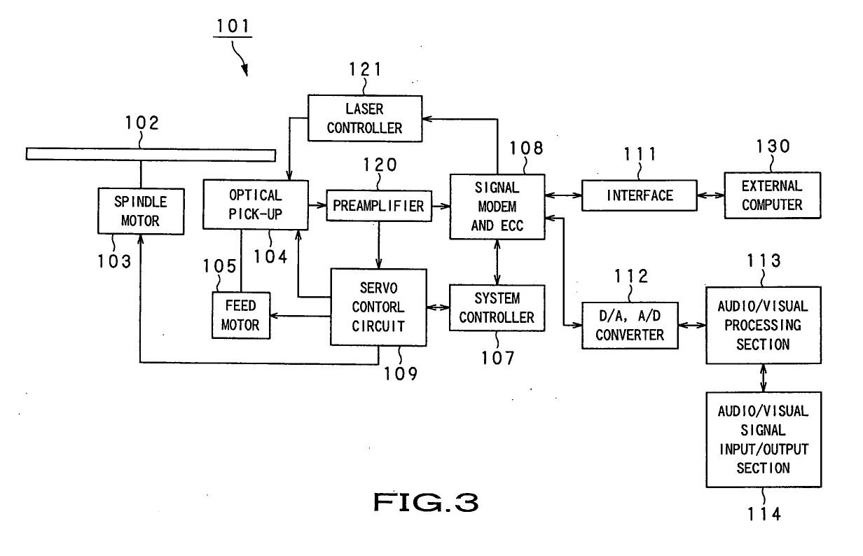

FIG. 3 shows an optical disc recording/reproduction apparatus 101 using an optical head according to the present invention. An optical disc recording/reproduction apparatus 101 includes a spindle motor 103 serving as a driving means for rotating an optical recording medium, that is, an optical disc 102, an optical pick-up 104 according to the present invention, and a feed motor 105 serving as a driving means for the optical pick-up 104. Examples of the optical disc 102 include optical discs of various systems using optical modulation recording or pit recording, or various types of magneto-optical recording media. There may be a difference in the optimal recording and/or reproduction optical power on the recording layer among them.

The driving operation of the spindle motor 103 is controlled by a system controller 107 and a servo control circuit 109 depending on the disc type.

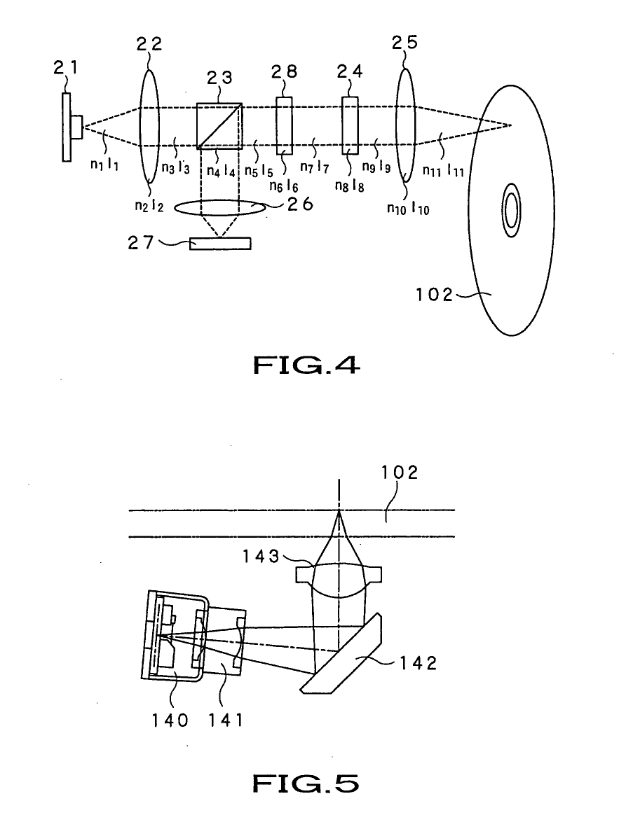

The optical pick-up 104 irradiates the recording layer of the optical disc 102 with a light flux and detects laser beam reflected by the recording layer, of the light flux. Further, the optical pick-up 104 detects various light fluxes to be described later from the laser beam reflected by the recording layer of the optical disc 102 and supplies a preamplifier 120 with signals corresponding to the respective light fluxes. The optical system of the optical pick-up 104 will be described later in detail with reference to FIG. 4.

An output of the preamplifier 120 is sent to a signal modem and an ECC block 108. The signal modem and ECC block 108 performs modulation and demodulation of the signal, and adds an ECC (Error-Correcting Code) to the signal. The optical pick-up 104 irradiates the recording layer of the optical disc 102 rotating according to the instruction of the signal modem and ECC block 108 with laser beam, and records/reproduces the signal onto or from the optical disc 102.

The preamplifier 120 generates a focus error signal, a tracking error signal, an RF signal, and the like based on the signals corresponding to the respective light fluxes. The servo control circuit 109, signal modem and ECC block 108, and the like perform predetermined signal processing such as demodulation and error correction based on these signals received by the preamplifier 120.

If the optical disc 102 is, for example, for data storage of computer, demodulated recording signal is sent to an external computer 130 and the like through an interface 111. The external computer 130 and the like receives, as reproduction signal, a signal recorded on the optical disc 102.

Moreover, if the optical disc 102 is optical disc for the so-called audio/visual, the signal is subjected to undergo digital/analog conversion at the D/A converting section of a D/A, A/D converter 112, and is delivered to an audio/visual processing section 113. Further, the signal delivered to the audio/visual processing section 113 is subjected to undergo audio/visual signal processing at the audio/visual processing section 113, and is transmitted to an external device through an audio/visual signal input/output section 114.

The optical pick-up 104 is operated to move to a predetermined recording track on the optical disc 102 by the feed motor 105. Control of the spindle motor 103, control of the feed motor 105, and controls for drive in the focusing direction and drive in the tracking direction of the biaxial actuator which holds object lens serving as a light converging means at the optical pick-up 104 are respectively performed by the servo control circuit 109.

The servo control circuit 109 operates a light coupling efficiency adjustable element disposed within the optical pick-up 104 to conduct a control such that light coupling efficiency at the optical pick-up 104, i.e., ratio between total light quantity of light fluxes emitted from laser light source such as laser diode element, and light quantity converged onto the optical disc 102 is changed between the recording mode and reproduction mode, or in accordance with the type of the optical disc 102.

A laser controller 121 controls laser light source at the optical pick-up 104. Particularly, in this embodiment, the laser controller 121 conducts a control such that output power of the laser light source at the time of recording mode and that at the time of reproduction mode are different from each other.

The servo control circuit 109 serving as a light coupling efficiency control means is controlled by the system controller 107 to thereby control light coupling efficiency at the optical pick-up 104. Further, the servo control circuit 109 detects relative positions, for example, between the optical pick-up 104 and optical disc 102 (including the case of detecting the positions based on the address signal recorded on the disc 102), thereby discriminating the recording region to be recorded or reproduced. In accordance with the discrimination result, the servo control circuit 109 controls the light coupling efficiency at the optical pick-up 104.

The optical pick-up 104 according to the embodiment of the present invention, which constitutes the optical disc recording/reproduction apparatus 101, will next be described with reference to FIG. 4. As shown in FIG. 4, the optical pick-up 4 includes, as a recording/reproduction beam emission system, a laser light source 21 that emits a light flux for recoding/reproduction, a collimator lens 22 that is disposed in the light emission direction of the laser light source 21 and changes the light flux into parallel laser beam, a polarization beam splitter 23 disposed on the light emission side of the collimator lens 22, a ¼ wavelength plate 24 serving as an optical isolator, and an objective lens 25 that condenses the parallel light flux from the laser light source on the optical disc 102. Further, the optical pick-up 104 includes, as a detection system, a condenser lens 26 that condenses the laser beam that has been reflected by the optical disc 102 and then polarized by the polarization beam splitter 23 onto a photodetector, and a photodetector 27 that receives the light flux that has been modulated by the recording surface of the optical disc 102 and converts the light flux into an electrical signal.

In the optical pick-up 104, laser beam that has been emitted from the laser light source 21 is incident on the optical disc 102; and the laser beam reflected by the optical disc 102 is condensed onto the photodetector 27 and is converted into an electrical signal. In the optical path from the laser light source 21 to the photodetector 27, laser beam that has been emitted from the laser light source 21 is changed into parallel laser beam by the collimator lens 22, passed through the polarization beam splitter 23, and condensed and incident on the optical disc 102 by the objective lens 25. The laser beam reflected by the optical disc 102 is changed into the parallel laser beam by the objective lens 25, separated from the light to be incident on the optical disc 102 by the polarization beam splitter 23, and condensed on the photodetector 27 by the condenser lens 26.

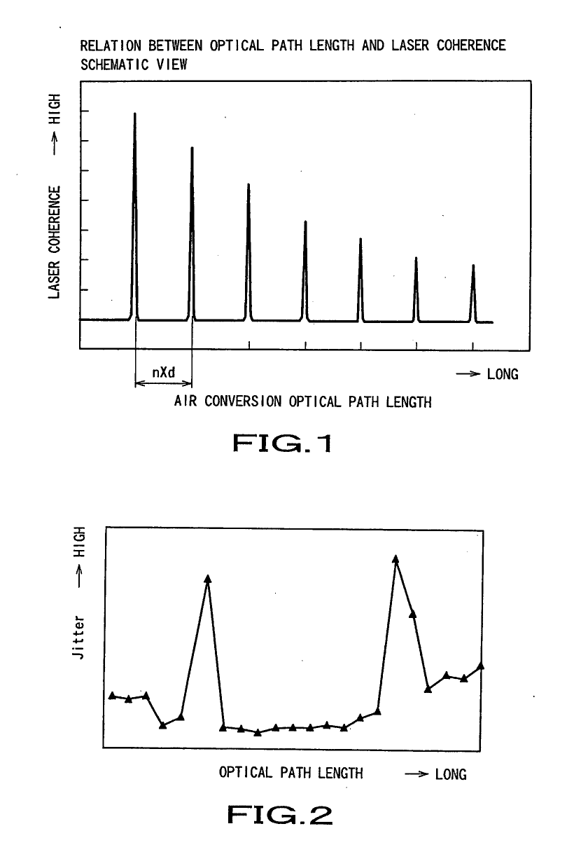

In the optical system, generally, laser noise (optical feedback noise) is generated. More specifically, laser beam that has been emitted from the laser diode and focused onto the recording surface of an optical disc partly moves back through the forward passage of an optical system and returns to the laser diode. This returning laser beam is referred to as “optical feedback” and interferes with the emitted laser beam, causing laser noise. The amount of noise caused by interference between emitted laser beam and the optical feedback depends on the optical path length, as shown in FIG. 1. Assuming that d is the resonator length of a laser diode and n is the refractive index of an active layer, air conversion optical path length L of all optical components in the forward passage of an optical system between a laser emission point and the surface of a disc-shaped recording medium has a plurality of peaks at some intervals, which meets the following equation.
L=i×(n×d)

(i is an arbitrary integer)

In the optical pick-up 104, the air conversion optical path length L of all optical components in the forward passage of an optical system between a laser emission point and the surface of a disc-shaped recording medium is controlled to have a value that does not coincide with the peaks in the above equation. Since there exists surface blurring in the optical disc or spindle in practice, the optical pick-up needs to allow the objective lens to perform focusing while following the surface blurring. That is, “surface blurring” can be a factor that inevitably changes the air conversion optical path length L in the forward passage of an optical system. Assuming that the surface blurring is mainly caused by angular misalignment of the optical disc attachment surface, it is presumable that the largest fluctuation in the optical path length is observed at disc outermost portion. Thus, in the present embodiment, for the determination of the air conversion optical path length L, acceptable surface blurring of the optical disc is taken into consideration.

To be more specific, acceptable surface blurring ΔL at the outermost portion of a Mini Disc (MD) and UMD is standardized to about 0.4 mm, acceptable surface blurring ΔL of a DVD is to about 0.6 mm, and acceptable surface blurring ΔL of a CD is to about 0.8 mm.

In consideration of the above, the air conversion optical path length L of an optical system required to reduce the optical feedback noise in practice is represented by the following inequality (1).
i(n₀×d)+ΔL/2<L<(i+1)(n₀×d)−ΔL/2 (1)

(i is an arbitrary integer)

where L is air conversion optical path length of the entire forward passage of an optical system between a laser emission point and the recording surface of an optical disc, d is resonator length of a laser diode, n₀ is active layer refractive index of the laser diode, and ΔL is acceptable surface blurring in the specification of the disc-shaped recording medium. The air conversion optical path length L is represented by: (refractive index of a medium, such as lens, capable of transmitting laser beam)×(optical path length of laser beam passing the medium). Accordingly, the air conversion optical path length L can also be represented by the following equation (2) (see FIG. 4).
L=n₁l₁+n₂l₂+ . . . +nₘlₘ+ . . . (2)
where nₘ is refractive index of each medium in the optical path, and lₘ is length of the medium.

Therefore, any parameter shown in FIG. 4 can be used to optimize the air conversion optical path length L. For example, by changing the refractive index and length of a parallel plate 28, which is newly provided in the optical path as shown in FIG. 4, the air conversion optical path length L can be optimized. Alternatively, the thickness or refractive index of at least one lens of the lenses in the optical system may be changed to optimize the air conversion optical path length L.

A description will be given of an example (FIGS. 5 to 7) in which the optical system according to the present invention is realized. In the example described below, the optical pick-up 104 is provided as a laser coupler obtained by integrating the emission and detection systems of the recording/reproduction beam. The resonator length d of the laser diode is selected in accordance with the type or the like of the optical disc, and selected, for example, from a value between 250 to 900 μm. The active layer refractive index n is generally about 4.

An optical system 1 shown in FIG. 5 includes a laser coupler (LC) 140 obtained by combining a laser diode (LD) and a photodetector (PD) that receives the light flux that has been reflected and modulated by the optical disc 102 and converts the modulated light flux into an electrical signal, a coupling lens 141 that is disposed near the laser coupler 140 and changes the light flux into substantially parallel light flux, a flat plate mirror 142 for changing the direction of the laser beam in the vertical direction, and an objective lens 143 disposed near the optical disc 102. In the optical system 1 having the above components, the air conversion optical path length L represented by the above equation (2) is optimized by changing the center thickness of the coupling lens 141. The air conversion optical path length L can be optimized by changing the thickness of the objective lens 143. In this case, however, the entire thickness of the optical pick-up 104 is increased to prevent miniaturization of the optical pick-up. Thus, it is preferable that optical path parallel to the radial direction of the optical disc 102, which hardly increases the thickness of the optical pick-up 104, is used to optimize the air conversion optical path length L. That is, the thickness of the coupling lens 141 is changed to optimize the air conversion optical path length L.

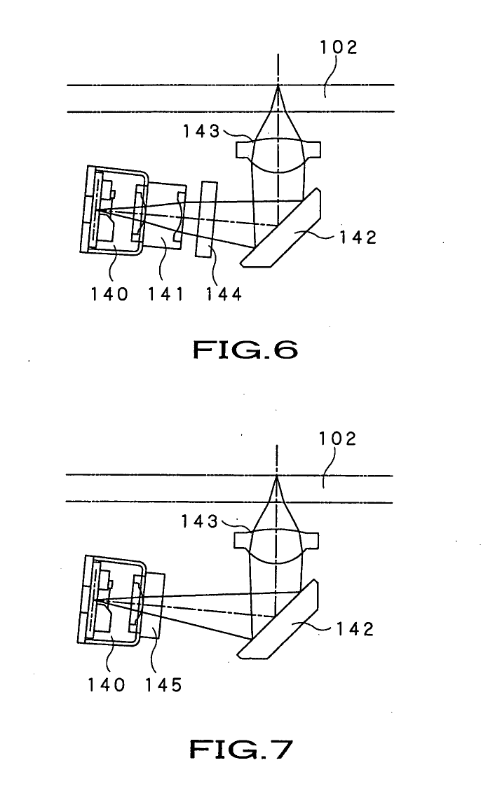

An optical system 2 shown in FIG. 6 includes a laser coupler (LC) 140 obtained by combining a laser diode (LD) and a photodetector (PD) that receives the light flux that has been reflected and modulated by the optical disc 102 and converts the modulated light flux into an electrical signal, a coupling lens 141 that is disposed near the laser coupler 140 and changes the light flux into substantially parallel light flux, a flat plate mirror 142 for changing the direction of the laser beam in the vertical direction, and an objective lens 143 disposed near the optical disc 102, as well as a liquid crystal device (LCD) 144 for compensating phase difference of the modulated light flux. The liquid crystal device 144 is generally constituted by two parallel flat plates and a liquid crystal interposed between the flat plates. By the thickness of these flat plates, the air conversion optical path length L is optimized. As described above, in the optical system 2, by adjusting the thickness of the parallel flat plates, it is possible to optimize the optical path length without impairing the function of the liquid crystal device, thereby reducing the optical feedback noise.

In the case where an optical system having functions of aberration correction, light amount correction, apodization and the like realized using the liquid crystal is used, by changing the refractive index or length of any optical component according to the example described above, the optimization can be achieved. The liquid crystal device to be used can be a phase compensation plate obtained by bonding a phase difference film to the parallel flat plates, or a filter (ND filter, dichroic filter, or the like) for restricting light amount.

An optical system 3 shown in FIG. 7 includes a laser coupler (LC) 140 obtained by combining a laser diode (LD) and a photodetector (PD) that receives the light flux that has been reflected and modulated by the optical disc 102 and converts the modulated light flux into an electrical signal, a protection lid 145 made of a flat glass capable of transmitting light that is disposed at the light emission portion of the laser coupler 140 and protects the inside of the laser coupler 140, a flat plate mirror 142 for changing the direction of the laser beam in the vertical direction, and an objective lens 143 disposed near the optical disc 102. In the optical system 3, the air conversion optical path length L is optimized by the thickness of the protection lid 145.

According to the optical pick-up 104, as described above, laser characteristics can be assured in the range of the optical path L including the surface blurring of the optical disc 102. Further, the optical feedback noise can be reduced without the need of using a conventional high-frequency superposed and self-excited oscillation laser. Therefore, a reduction in the size, thickness, weight, and power consumption can be achieved, resulting in a reduction of the size, thickness, and weight of the optical disc recording/reproduction apparatus 101. Since the optical feedback noise can be reduced without using a conventional high-frequency superposed and self-excited oscillation laser as described above, the tolerance of the laser diode itself can be relaxed, contributing to cost reduction and improvement in yield. Further, the optical pick-up 104 can be obtained at low cost by optimizing the optical distance determined by the refractive index and length of any component in the optical path such that the equation (2) is satisfied.

The optical feedback noise is generally generated when the temperature environment is changed. In particular, the noise frequently occurs at a low temperature. This is because coherence is increased at a low temperature. However, in the optical pick-up 104 according to the present invention, the air conversion optical path length L corresponds to an optical path length of a valley between the peaks in the graph shown in FIG. 1, in which the optical feedback noise hardly occurs. Therefore, the optical pick-up 104 is not influenced by the increase in coherence due to the temperature change. As a result, the optical pick-up 104 can maintain favorable environmental characteristics independent of the temperature change without increasing laser capability, although the tolerance of the laser diode itself has been relaxed.

The present invention can be applied to an optical pick-up that can record/reproduce data onto or from recording and/or reproducing discs of various systems including pit recording, magneto-optic recording, phase change recording, and dye recording, that is, CD-ROM, DVD-ROM, and UMD, CD-R/RW, DVD-RAM, DVD-R/RW, DVD+RW which realize high-density recording, or an optical pick-up that can record/reproduce data onto or from various types of magneto-optic recording media.

1. An optical pick-up comprising a laser diode, wherein
air conversion optical path length L of all optical components in the forward passage of an optical system between a laser emission point and the surface of a disc-shaped recording medium is represented by:
i(n₀×d)+ΔL/2<L<(i+1)(n₀×d)−ΔL/2
(i is an arbitrary integer)
where d is resonator length of a laser diode, n₀ is active layer refractive index of the laser diode, and ΔL is acceptable surface blurring in the specification of the disc-shaped recording medium.

2. The optical pick-up according to claim 1, wherein
the air conversion optical path length L is represented by the following equation:
L=n₁l₁+n₂l₂+ . . . +nₘlₘ+ . . .
where nₘ is refractive index of each medium in the optical path, and lₘ is length of the medium, and satisfies the above inequality in the claim 1.

3. The optical pick-up according to claim 2, comprising a parallel plate having the medium refractive index and length that satisfy the air conversion optical path length L.

4. The optical pick-up according to claim 2, wherein the air conversion optical path length L is optimized based on the thickness or refractive index of at least one lens of the lenses disposed in the optical system.

5. The optical pick-up according to claim 4, wherein the lens thickness is optimized based on the length in the radial direction of the disc-shaped recording medium that faces the optical pick-up.

6. The optical pick-up according to claim 4, comprising a laser coupler constituted by a light emitting device and light detection means that receives the laser beam that has been modulated by the surface of the disc-shaped recording medium, the laser coupler having a flat glass capable of transmitting the laser light that protects the inside of the coupler, wherein
the air conversion optical path length L is optimized based on the thickness of the flat glass.

7. The optical pick-up according to claim 4, comprising a laser coupler constituted by a light emitting device and light detection means that receives the laser beam that has been modulated by the surface of the disc-shaped recording medium, and a coupling lens that is disposed near the laser coupler and changes the light flux into substantially parallel light flux, wherein
the air conversion optical path length L is optimized based on the thickness of the coupling lens.

8. The optical pick-up according to claim 4, comprising a laser coupler constituted by a light emitting device and light detection means that receives the laser beam that has been modulated by the surface of the disc-shaped recording medium, a coupling lens that is disposed near the laser coupler and changes the light flux into substantially parallel light flux, and a liquid crystal optical device that compensates phase difference of the light flux, wherein
the air conversion optical path length L is optimized based on the thickness of the liquid crystal optical device.

9. The optical pick-up according to claim 3, wherein the parallel plate serves as an optical device having functions corresponding to those of the flat glass, coupling lens, and liquid crystal device.

10. The optical pick-up according to claim 1, wherein the disc-shaped recording medium is a CD (Compact Disc™) having acceptable surface blurring ΔL of 0.8 mm.

11. The optical pick-up according to claim 1, wherein the disc-shaped recording medium is an MD (Mini Disc™) having acceptable surface blurring ΔL of 0.4 mm.

12. The optical pick-up according to claim 1, wherein the disc-shaped recording medium is a DVD (Digital Versatile Disc) having acceptable surface blurring ΔL of 0.6 mm.

13. The optical pick-up according to claim 1, wherein the disc-shaped recording medium is a UMD (Universal Media Disc) having acceptable surface blurring ΔL of 0.4 mm.

14. An optical recording medium recording/reproducing apparatus rotatably driving an optical recording medium, having an optical pick-up for recoding/reproduction that is moved in the radial direction of the optical recording medium by feed means, and controlling the rotation of the optical recording medium and the movement of the optical pick-up in association with recording and/or reproduction operation,
the optical pick-up having a laser diode, wherein
air conversion optical path length L of all optical components in the forward passage of an optical system between a laser emission point and the surface of a disc-shaped recording medium is represented by:
i(n₀×d)+ΔL/2<L<(i+1)(n₀×d)−ΔL/2
(i is an arbitrary integer)
where d is resonator length of a laser diode, n₀ is active layer refractive index of the laser diode, and ΔL is acceptable surface blurring in the specification of the disc-shaped recording medium.
